(19) United States
(12) Patent Application Publication
(10) Pub. No.: US 2020/0059567 A1
(43) Pub. Date: Feb. 20, 2020

(54) DATA COMMUNICATION DEVICE AND DATA COMMUNICATION METHOD

(71) Applicant: SHARP KABUSHIKI KAISHA, Sakai City (JP)

(72) Inventors: MAKOTO HIGUCHI, Sakai City (JP); MOTOHIRO HAYASHI, Sakai City (JP)

(21) Appl. No.: 16/519,228

(22) Filed: Jul. 23, 2019

(30) Foreign Application Priority Data
Aug. 20, 2018 (JP) 2018-154103

(51) Int. Cl. H04N 1/00; H04L 12/58

(52) U.S. Cl. CPC H04N 1/00212; H04L 51/066; H04N 1/00225; H04N 1/00214

(57) ABSTRACT

A data communication device that performs e-mail communication includes: an e-mail transmitter that attaches an image to an e-mail, and then transmits the e-mail; an image data detector that detects a data amount of an input image; an image data amount determiner that determines whether or not a data amount of the image attached to the e-mail exceeds a preset data amount; a communication controller that enables transmission of the e-mail if the data amount of the image does not exceed the preset data amount; and a data amount controller that performs data amount reduction processing of reducing the image data amount if the data amount of the image exceeds the preset data amount.

### BACKGROUND OF THE INVENTION

### Field of the Invention

The present invention relates to a data communication device and the like, more specifically, to a data communication device and the like that attaches an image to an e-mail, and then transmits the e-mail.

### Description of the Background Art

In recent years, data communication devices configured to be capable of attaching an image to an e-mail, and then transmitting the e-mail are known.

As a conventional technique, for example, there is disclosed a technique of using a data communication device including: an input means that inputs data in page units; a transmission means that attaches the data of a plurality of pages to an e-mail, and then transmits the e-mail; a control means that divides an input plurality of pages at a page break if the data amount when the data of the input plurality of pages is attached and then transmitted exceeds a predetermined set value, and performs control to transmit a plurality of e-mails each having the data of one or more divided pages attached thereto; and a determination means that determines, prior to the start of transmission by the transmission means, whether or not the input plurality of pages include a page for which the data amount when the data of the page is attached to a single e-mail and then transmitted exceeds the predetermined set value, wherein if it is determined, from the determination result from the determination means, that the input plurality of pages include a page for which the data amount when the data of the page is attached to a single e-mail and then transmitted exceeds the predetermined set value, the control means performs control such that none of the input plurality of pages is transmitted (see Japanese Unexamined Patent Application Publication No. 2001-350700).

According to the technique proposed in Japanese Unexamined Patent Application Publication No. 2001-350700, for example, if a preset upper limit size is exceeded by a single image, a notification indicating that “the transmission data volume exceeds the upper limit” is issued, and the communication itself is cancelled and the data is not transmitted. When transmission fails, a user is required to retry the image reading operation from the beginning after changing the image reading settings (such as the resolution, the image quality, and grayscaling).

The present invention has been made in view of the conventional problems described above, and the object thereof is to provide a data communication device and the like which, when attaching an image to an e-mail and then transmitting the e-mail, can reliably transmit the e-mail with the attached image.

### SUMMARY OF THE INVENTION

The present invention provides a data communication device that performs e-mail communication and includes: an e-mail transmitter that attaches an image to an e-mail, and then transmits the e-mail; an image data detector that detects a data amount of an input image (read image); an image data amount determiner that determines whether or not a data amount of the image attached to the e-mail exceeds a preset data amount; a communication controller that enables transmission of the e-mail if the data amount of the image attached to the e-mail does not exceed the preset data amount; and a data amount controller that performs data amount reduction processing of reducing the image data amount if the data amount of the image attached to the e-mail exceeds the preset data amount.

Further, the present invention provides a data communication method for a data communication device that performs e-mail communication, the data communication method including: attaching an image to an e-mail, and then transmitting the e-mail; detecting a data amount of an input image (read image); determining whether or not a data amount of the image attached to the e-mail exceeds a preset data amount; enabling transmission of the e-mail if the data amount of the image attached to the e-mail does not exceed the preset data amount; and performing data amount reduction processing of reducing the image data amount if the data amount of the image attached to the e-mail exceeds the preset data amount.

According to the data communication device of the present invention, the data communication device that performs e-mail communication includes: an e-mail transmitter that attaches an image to an e-mail, and then transmits the e-mail; an image data detector that detects a data amount of an input image (read image); an image data amount determiner that determines whether or not a data amount of the image attached to the e-mail exceeds a preset data amount; a communication controller that enables transmission of the e-mail if the data amount of the image attached to the e-mail does not exceed the preset data amount; and a data amount controller that performs data amount reduction processing of reducing the image data amount if the data amount of the image attached to the e-mail exceeds the preset data amount. As a result, even if the data amount of the attached image exceeds a preset upper limit size, the image can be attached to the e-mail and then transmitted.

Furthermore, according to the data communication method of the present invention, the data communication method for a data communication device that performs e-mail communication includes: attaching an image to an e-mail, and then transmitting the e-mail; detecting a data amount of an input image (read image); determining whether or not a data amount of the image attached to the e-mail exceeds a preset data amount; enabling transmission of the e-mail if the data amount of the image attached to the e-mail does not exceed the preset data amount; and performing data amount reduction processing of reducing the image data amount if the data amount of the image attached to the e-mail exceeds the preset data amount. As a result, even if the data amount of the attached image exceeds a preset upper limit size, the image can be attached to the e-mail and then transmitted.

### BRIEF DESCRIPTION OF THE DRAWINGS

FIG. 1 is a block diagram showing a configuration of a data communication device according to a first embodiment;

FIG. 2 is a flowchart showing processing steps for attaching an image to an e-mail and then transmitting the e-mail in the data communication device;

FIG. 3 is an explanatory diagram showing a configuration in which images are attached to an e-mail by the data communication device;

FIG. 4 is an explanatory diagram showing an example of a setting screen displayed on an operation unit of the data communication device;

FIG. 5 is an explanatory diagram showing an example of an image reading mode setting screen displayed on the operation unit of the data communication device;

FIG. 6 is an explanatory diagram showing an example of a resolution setting screen displayed on an operation unit of a data communication device according to a second embodiment;

FIG. 7 is an explanatory diagram showing a format setting screen (color/grayscale) according to Example 1, which is displayed on an operation unit of a data communication device according to a third embodiment;

FIG. 8 is an explanatory diagram showing a format setting screen (black and white) according to Example 1, which is displayed on the operation unit of the data communication device;

FIG. 9 is an explanatory diagram showing a format setting screen (color/grayscale) according to Example 2, which is displayed on the operation unit of the data communication device;

FIG. 10 is an explanatory diagram showing a format setting screen (black and white) according to Example 2, which is displayed on the operation unit of the data communication device;

FIG. 11 is an explanatory diagram showing a document setting screen displayed on an operation unit of a data communication device according to a fourth embodiment;

FIG. 12 is an explanatory diagram showing a density setting screen displayed on an operation unit of a data communication device according to a fifth embodiment; and

FIG. 13 is an explanatory diagram showing an additional function setting screen displayed on an operation unit of a data communication device according to a sixth embodiment.

### DESCRIPTION OF THE PREFERRED EMBODIMENTS

### First Embodiment

Hereinafter, a first embodiment of the present invention will be described with reference to the drawings.

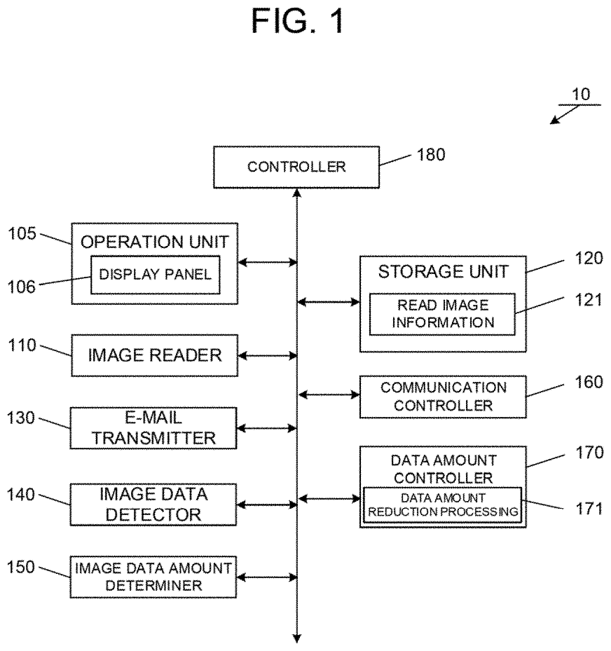

FIG. 1 is a block diagram showing a configuration of a data communication device according to the first embodiment.

Configuration of Data Communication Device A data communication device 10 according the first embodiment includes, as shown in FIG. 1, an operation unit 105, an image reader 110, a storage unit 120, an e-mail transmitter 130, an image data detector 140, an image data amount determiner 150, a communication controller 160, a data amount controller 170, and a controller 180 that performs control of the operation of respective parts of the device. The data communication device 10 enables transmission of an e-mail with an attached image.

The operation unit 105 includes a display panel 106. The display panel 106 displays a display screen for touch operations. The operation unit 105 is configured such that settings of respective parts of the device and instruction operations can be performed on the display screen.

The image reader 110 reads an image, and is, for example, a scanner.

The storage unit 120 stores the data of an image read by the image reader 110 as read image information 121.

The e-mail transmitter 130 attaches a read image to an e-mail, and then transmits the e-mail.

The image data detector 140 detects the data amount of a read image.

In the data communication device 10, the image data amount that can be attached to an e-mail and then transmitted is preset. The maximum value of the data amount is configured to be set and changed.

The image data amount determiner 150 determines whether or not the data amount of the image attached to an e-mail exceeds a preset data amount.

The communication controller 160 enables transmission of an e-mail if the data amount of the image attached to an e-mail does not exceed a preset data amount.

The data amount controller 170 performs data amount reduction processing 171 that reduces the image data amount if the data amount of the image attached to an e-mail exceeds a preset data amount.

The data amount reduction processing 171, for example, is processing of compressing image data to reduce the image data amount. As a result, an image attached to an e-mail can be made a data amount which does not exceed a preset data amount.

Transmission of E-mail by Data Communication Device Next, the processing performed in the data communication device 10 for attaching a read image to an e-mail and then transmitting the e-mail will be described following a flowchart.

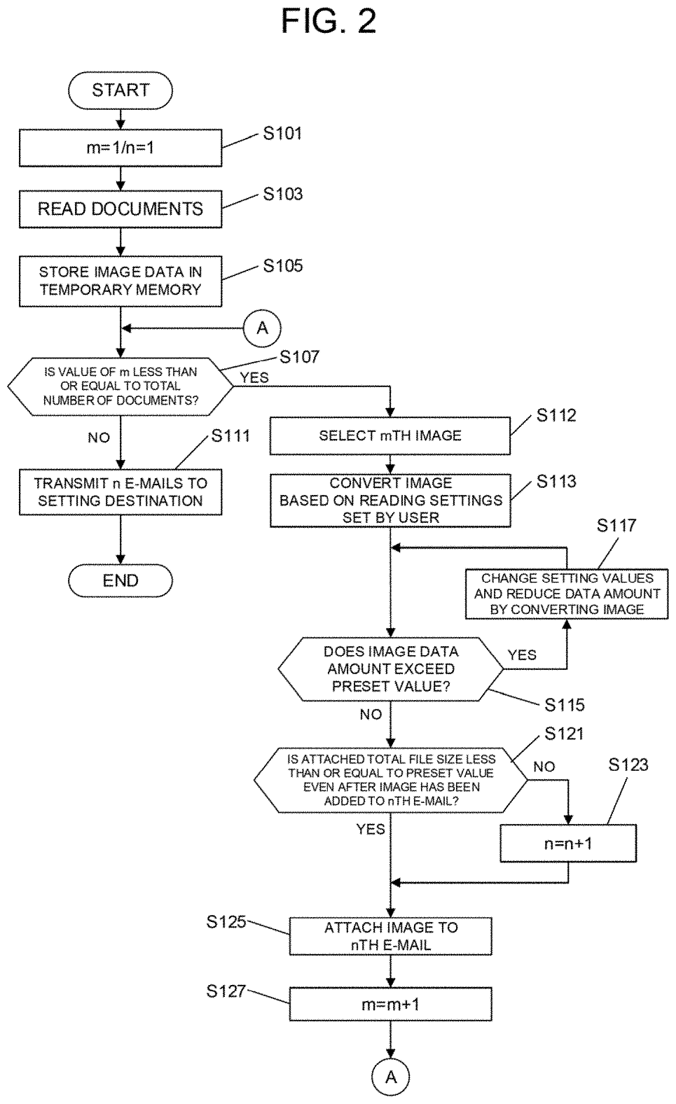

FIG. 2 is a flowchart showing processing steps for attaching an image to an e-mail and then transmitting the e-mail in the data communication device according to the first embodiment.

As shown in FIG. 2, when a read image is attached to an e-mail and then transmitted in the data communication device 10, the image reader 110 starts reading documents with values of m=1 and n=1 (step S101), where “m” refers to an image of the mth document to be read and “n” refers to the nth e-mail to be transmitted. All of the documents are then read in a high resolution (step S103).

Here, after temporarily reading all of the documents in color with a high resolution in step S103, each of the images are converted in step S113 using reading conditions set by a user. However, for example, data may be acquired for all of the documents in step S103 using the reading conditions set by the user. In this case, the procedure in step S113 is unnecessary.

The image data of all of the documents read by the image reader 110 is temporarily stored in the storage unit 120. The number of documents is also stored at this time (step S105).

Then, it is determined whether or not the value of m is less than or equal to the total number of documents (step S107). In step S107, it is determined that m is not less than or equal to the total number of documents when images of all of the documents have been read and all of the images have been attached to n e-mails. Then, the n e-mails to which the images have been attached are transmitted to a set destination (step S111), and the e-mail transmission processing ends.

On the other hand, if it is determined that the value of m is less than or equal to the total number of documents in step S107, an image of the mth document is selected (step S112). Then, color high-resolution image data is converted by the data amount controller 170 based on reading settings set by the user (step S113). Further, it is determined by the image data amount determiner 150 whether or not the data amount of the converted mth image exceeds the preset data amount (step S115).

In step S115, if it is determined that the data amount of the converted mth image exceeds the preset data amount, the data amount controller 170 changes a setting value of the data amount reduction processing and converts the image so as to reduce the data amount (step S117). If the image data amount is greater than or equal to an upper limit of the preset data amount, the setting value is changed and the data amount reduction processing in step S117 is repeated until the data amount is less than or equal to the upper limit. In the data amount reduction processing, it is desirable for the reduction processing to be prioritized in the order of compression rate, followed by resolution, and then color mode.

On the other hand, in step S115, if it is determined that the data amount of the converted image does not exceed the preset data amount, it is determined whether or not the total file size of the nth e-mail including attached images is less than or equal to a preset value even after addition of the image (step S121).

In step S121, if it is determined that the total file size of the nth e-mail including attached images is less than or equal to the preset value even after addition of the image, the image is attached to the nth e-mail (step S125).

Then, the value of m is set to m=m+1 (step S127), and the flow proceeds to step S107.

On the other hand, in step S121, if it is determined that the total file size of the nth e-mail including attached images is not less than or equal to the preset value after addition of the image, the value of n is set to n=n+1 (step S123), and the flow proceeds to step S125, step S127, and step S107.

In this manner, processing of selecting the next image and attaching the image to the next e-mail is repeated.

In the first embodiment, the image reading processing is performed consecutively by the image reader 110, and the images to be attached are selected thereafter so as to determine the image data amount. However, the processing of reading the images and selecting the images to be attached so as to determine the data amount is not limited to this. Image reading may be performed for each image to be attached, followed by determination of the image data amount.

Attachment of Image to E-mail Next, a case where a plurality of images are attached to an e-mail and then transmitted by the data communication device 10 according to the first embodiment will be described with reference to the drawings.

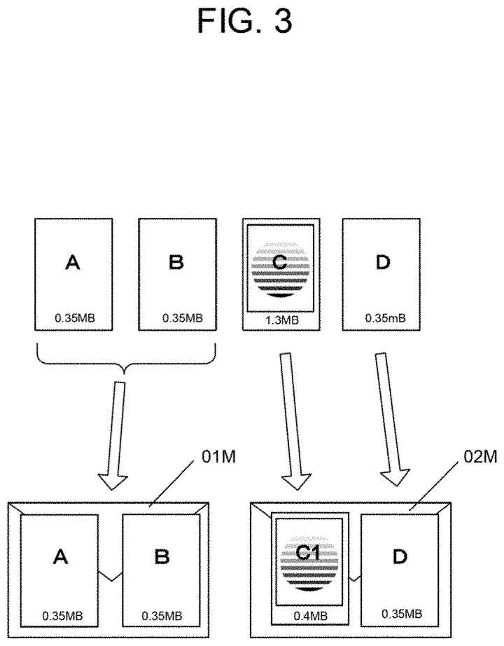

FIG. 3 is an explanatory diagram showing a configuration in which images are attached to an e-mail by the data communication device according to the first embodiment.

In the flowchart in FIG. 2, if color high-resolution read data of the documents is acquired in step S103, the image file sizes under the reading conditions set by the user are undetermined. Therefore, in the description here, a case where all of the images are converted under the reading conditions set by the user in step S113, or a case where the image are read under the reading conditions set by the user in step S103, are assumed.

In the first embodiment, as shown in FIG. 3, four images A, B, C, and D are read from each page by the image reader 110.

The data amount of each image A, B, C, and D is detected by the image data detector 140. Then, the data amount of each image A, B, C, and D is stored in the storage unit 120 as read image information 121.

The data amount of each image detected by the image data detector 140 is, as shown in FIG. 3, 0.35 MB for image A, 0.35 MB for image B, 1.3 MB for image C, and 0.35 MB for image D.

Here, in the first embodiment, the data amount of images that can be attached to an e-mail is set to 1 MB in the data communication device 10. If the data amount of the image attached to an e-mail does not exceed 1 MB, a plurality of images can be attached to a single e-mail.

If there is an image, the data amount of which exceeds the preset data amount, the communication controller 160 causes the data communication device 10 to notify the user that an image exists that exceeds the preset data amount. Then, the file size of the image may be automatically reduced under preset conditions.

In addition, the data communication device 10 may reduce the file size of the image under preset conditions without notifying the user that an image exists that exceeds the preset data amount.

Here, because the data amount of image C is 1.3 MB, which exceeds the image data amount capable of being attached to an e-mail, the data amount is reduced by data amount reduction processing 171.

In the first embodiment, the data amount controller 170 performs data amount reduction processing 171, which reduces the data amount by increasing the compression rate of the data of image C. As a result, as shown in FIG. 3, the data amount of image C is reduced from 1.3 MB to 0.4 MB, and can be made smaller than the image data amount capable of being attached to an e-mail (1 MB).

If the four images A, B, C, and D arranged in the order A, B, C, and D are attached to an e-mail, as shown in FIG. 3, for example, the image A (0.35 MB) and the image B (0.35 MB), which have not been subjected to reduction processing, may be attached to a first e-mail 01M. Further, an image C1 (0.4 MB), which is obtained by subjecting the image C to reduction processing, and the image D (0.35 MB), which has not been subjected to reduction processing, may be attached to a second e-mail 02M.

Furthermore, the image C (0.4 MB), which has been subjected to reduction processing, and the image D (0.35 MB), which has not been subjected to reduction processing, may be attached to separate e-mails.

In the first embodiment, the image C obtained by reduction processing, and the subsequent image D are attached to a single e-mail. However, for example, if the image data amount capable of being attached to an e-mail is set to 1.5 MB, and the image data amount after combining the image C with the images attached to the e-mail to which the previous image is attached is still smaller than the image data amount capable of being attached, the image C may be attached to the e-mail to which the previous image is attached.

Furthermore, as the combination of the plurality of images attached to a single e-mail, a combination of images that minimizes the number of e-mails to be transmitted irrespective of the image order may be used.

In this manner, for the four images A, B, C, and D, if an image exists that exceeds the image data amount capable of being attached to an e-mail, it is possible to reduce the data amount by performing data amount reduction processing and transmitting the images over two or three e-mails. Further, by compressing the data of the four images A, B, C, and D, the images can also be aggregated and attached to an even smaller number of e-mails.

Furthermore, if reduction processing has been performed with respect to the data of an attached image, information indicating that reduction processing has been performed with respect to the data of the image may be added to the e-mail.

Furthermore, if a plurality of images is attached to a single e-mail and then transmitted, information indicating that a plurality of images is attached may be added to the e-mail text.

Moreover, the file name of an image attached to an e-mail may include a character string specifying the order of the image within a plurality of images.

If a plurality of e-mails with attached images exist, the communication controller 160 may successively transmit the e-mails from an e-mail with an attached image having a character string specifying the lowest numbered order of the attached images.

Furthermore, if a plurality of e-mails with attached images exist, information that relates to the images attached to all of the e-mails, and information that relates to the images attached to each e-mail, may be added to the e-mail text of all of the e-mails.

Image Reading Mode Next, data amount reduction processing according to an image reading mode in the data communication device 10 according to the first embodiment will be described in detail with reference to the drawings.

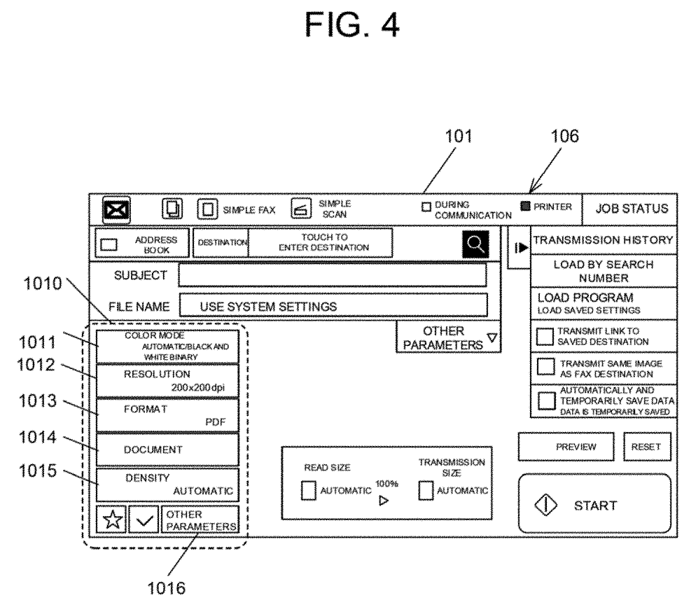

FIG. 4 is an explanatory diagram showing an example of a setting screen displayed on an operation unit of the data communication device according to the first embodiment.

As shown in FIG. 4, the display panel 106 of the operation unit 105 of the data communication device 10 according to the first embodiment (see FIG. 1) displays a setting screen 101 for performing various image reading settings.

The setting screen 101 is provided with a setting area 1010 that displays a color mode key 1011 that sets an image reading mode, a resolution setting key 1012 that sets an image resolution, a format setting key 1013 that sets an image format, a read document setting key 104 that sets a document size and the like, a density setting key 1015 that sets an image density, an additional function setting key 1016, and the like.

When performing settings of the data amount reduction processing, the setting operation is started by selecting and performing, a touch operation with respect to the color mode key 1011, the resolution setting key 1012, the format setting key 1013, the read document setting key 104, the density setting key 1015, or the additional function setting key 1016, according to the processing content that reduces the data amount.

In the first embodiment, processing of reducing the data amount by changing the image reading mode is performed as the data amount reduction processing.

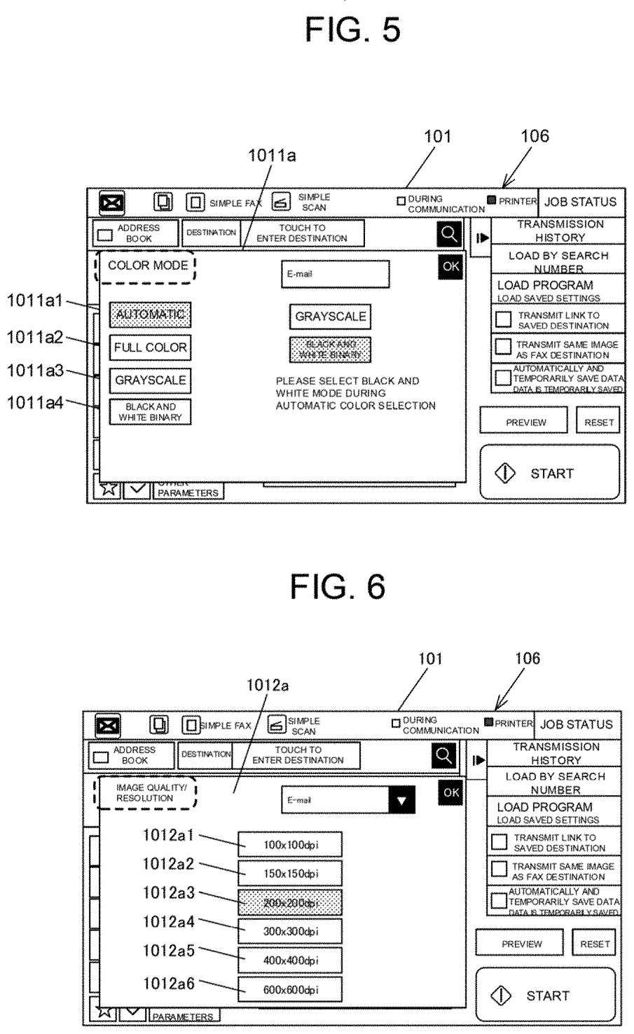

FIG. 5 is an explanatory diagram showing an example of an image reading mode setting screen displayed on the operation unit of the data communication device according to the first embodiment.

When the image reading mode is changed, a touch operation is performed with respect to the color mode key 1011 on the setting screen 101 shown in FIG. 4. As a result, a color mode setting screen 1011a is overlappingly displayed on the setting screen 101, as shown in FIG. 5.

The color mode setting screen 1011a displays an automatic color selection key 1011a1, a full color key 1011a2, a grayscale key 1011a3, a black and white key 1011a4, and the like.

When setting the reading mode, the desired reading mode is set by selecting and performing a touch operation with respect to the automatic color selection key 1011a1, the full color key 1011a2, the grayscale key 1011a3, or the black and white key 1011a4 according to the conditions under which the colors are to be read.

Then, the image data amount is adjusted according to the selected reading mode.

That is to say, the image data amount becomes larger if the full color mode is selected, and the image data amount becomes smaller if the black and white binary mode is selected. Therefore, depending on the state of the image to be read, the image data can be appropriately reduced by selecting the full color mode, the gray scale mode, or the black and white binary mode.

As a result of the configuration above, according to the first embodiment, an data communication device 10 that performs e-mail communication includes: an operation unit 105, an e-mail transmitter 130, an image data detector 140, an image data amount determiner 150 that determines whether or not a data amount of the image attached to an e-mail exceeds a preset data amount; a communication controller 160 that enables transmission of the e-mail if the data amount of the image attached to the e-mail does not exceed the preset data amount; and a data amount controller 170 that performs data amount reduction processing 171 of reducing the image data amount if the data amount of the image attached to the e-mail exceeds the preset data amount. Therefore, by reducing the image data amount if the data amount of the attached image exceeds a preset upper limit size, an image can be attached to an e-mail and then easily transmitted.

Furthermore, in the first embodiment, as the data amount reduction processing of reducing an image to be attached to an e-mail, the color mode setting screen 1011a is provided, and the image data amount is changed by changing the image reading mode. Therefore, the image data amount can be reduced in advance by changing the image reading mode according to the image at the time the image is read.

### Second Embodiment

Next, a second embodiment will be described with reference to the drawings.

For convenience of description, the same reference numerals are given to those configurations having the same functions as in the first embodiment, and the description will be omitted.

FIG. 6 is an explanatory diagram showing an example of a resolution setting screen displayed on an operation unit of a data communication device according to the second embodiment.

In the second embodiment, in the data communication device 10, processing of reducing the data amount by changing the image resolution is performed as the data amount reduction processing.

When the image resolution is changed, a touch operation is performed with respect to the resolution setting key 1012 on the setting screen 101 shown in FIG. 4. As a result, a resolution setting screen 1012a is overlappingly displayed on the setting screen 101 as shown in FIG. 6.

The resolution setting screen 1012a displays a 100×100 dpi setting key 1012a1, a 150×150 dpi setting key 1012a2, a 200×200 dpi setting key 1012a3, a 300×300 dpi setting key 1012a4, a 400×400 dpi setting key 1012a5, a 600×600 dpi setting key 1012a6, and the like.

When setting the image resolution, the desired resolution is set by selecting and performing a touch operation with respect to the 100×100 dpi setting key 1012a1, the 150×150 dpi setting key 1012a2, the 200×200 dpi setting key 1012a3, the 300×300 dpi setting key 1012a4, the 400×400 dpi setting key 1012a5, or the 600×600 dpi setting key 1012a6, according to the extent in which the image data amount is to be reduced.

Then, the image data amount is adjusted according to the selected resolution.

That is to say, the image data amount becomes smaller if the resolution is decreased to 200×200 or 100×100 dpi, and the image data amount becomes larger if the resolution is increased to 400×400 dpi or 600×600 dpi. Therefore, the image data can be appropriately reduced by selecting the resolution according to size of the image.

As a result of the configuration above, according to the second embodiment, in the data communication device 10 which performs e-mail communication, the data amount reduction processing of reducing an image to be attached to an e-mail includes the resolution setting screen 1012a, and changes the image data amount by changing the image resolution. Therefore, the image data amount can be reduced according to the size of the image.

### Third Embodiment

Next, a third embodiment will be described with reference to the drawings.

For convenience of description, the same reference numerals are given to those configurations having the same functions as in the first embodiment, and the description will be omitted.

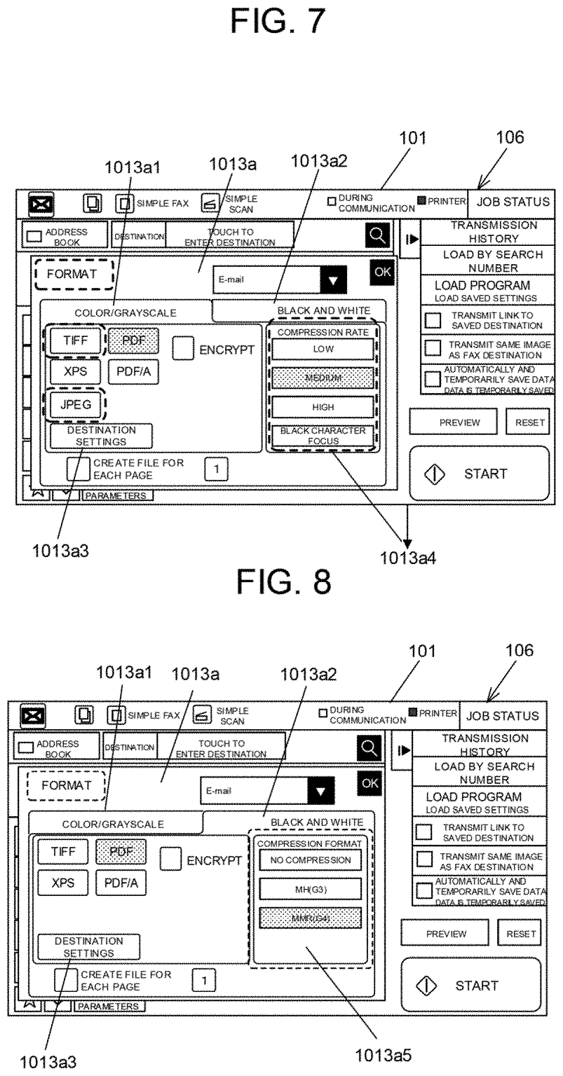

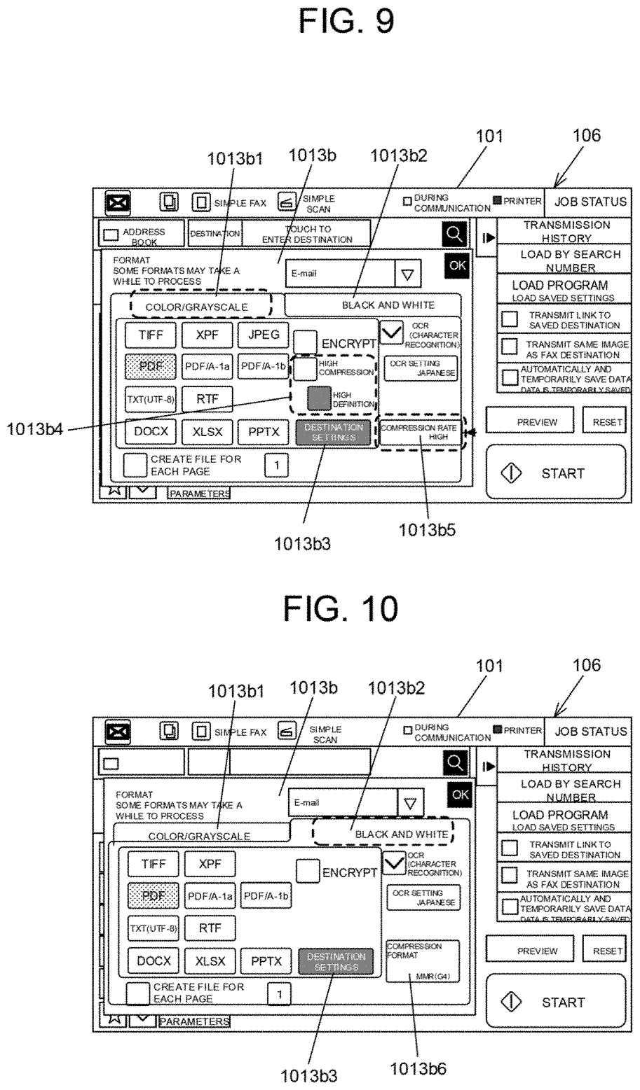

FIG. 7 is an explanatory diagram showing a format setting screen (color/grayscale) according to Example 1, which is displayed on an operation unit of a data communication device according to a third embodiment. FIG. 8 is an explanatory diagram showing a format setting screen (black and white) according to Example 1, which is displayed on the operation unit of the data communication device. FIG. 9 is an explanatory diagram showing a format setting screen (color/grayscale) according to Example 2, which is displayed on the operation unit of the data communication device. FIG. 10 is an explanatory diagram showing a format setting screen (black and white) according to Example 2, which is displayed on the operation unit of the data communication device.

In the third embodiment, in the data communication device 10, processing of reducing the data amount by changing the image format is performed as the data amount reduction processing.

### Example 1

In Example 1, when the image format is changed, a touch operation is performed with respect to the format setting key 1013 on the setting screen 101 shown in FIG. 4. As a result, a format setting screen 1013a is overlappingly displayed on the setting screen 101 as shown in FIG. 7.

The format setting screen 1013a includes a color/grayscale setting screen 1013a1 and a black and white setting screen 1013a2.

As shown in FIG. 7, file formats such as TIFF, XPS, JPEG, PDF, and PDF/A can be selected on the color/grayscale setting screen 1013a1. These file formats can be set for each destination by a destination setting key 1013a3.

Furthermore, the color/grayscale setting screen 1013a1 includes a compression rate setting portion 1013a4 that enables a compression rate to be selected.

As compression rates, “low”, “medium”, “high”, and “black character focus” can be selected.

As shown in FIG. 8, file formats such as TIFF, XPS, PDF, and PDF/A can be selected on the black and white setting screen 1013a2. These file formats can be set for each destination by the destination setting key 1013a3.

Furthermore, the black and white setting screen 1013a2 includes a compression format setting portion 1013a5 that enables a compression format to be selected. As compression formats, “no compression”, “MH (G3)”, and “MMR (G4)” can be selected.

### Example 2

In Example 2, when the image format is changed, a touch operation is performed in the same manner as in Example 1 with respect to the format setting key 1013 on the setting screen 101 shown in FIG. 4. As a result, a format setting screen 1013b is overlappingly displayed on the setting screen 101 as shown in FIG. 9.

The format setting screen 1013b includes a color/grayscale setting screen 1013b1 and a black and white setting screen 1013b2.

As shown in FIG. 9, file formats such as TIFF, XPS, JPEG, PDF, PDF/A-1a, PDF/A-1b, TXT (UTF-8), RTF, DOCX, XLSX, and PPTX can be selected on the color/grayscale setting screen 1013b1. These file formats can be set for each destination by a destination setting key 1013b3.

Furthermore, the color/grayscale setting screen 1013b 1 includes a compression rate setting portion 1013b4 that enables a compression rate to be selected. As compression rates, “high compression” and “high definition” can be selected.

The selected compression rate is displayed in a compression rate display portion 1013b5.

As shown in FIG. 10, file formats such as TIFF, XPS, JPEG, PDF, PDF/A-1a, PDF/A-1b, TXT (UTF-8), RTF, DOCX, XLSX, and PPTX can be selected on the black and white setting screen 1013b2. These file formats can be set for each destination by the destination setting key 1013b3.

Furthermore, the black and white setting screen 1013b2 is configured to be capable of setting the compression format, and the selected compression format is displayed in a compression format display portion 1013b6.

As a result of the configuration above, according to the third embodiment, in the data communication device 10 which performs e-mail communication, the data amount reduction processing of reducing an image to be attached to an e-mail includes the image format setting screens 1013a and 1013b, and changes the image data amount by changing the image format. Therefore, the image data amount can be reduced according to the file format setting, the compression rate, and the compression format.

### Fourth Embodiment

Next, a fourth embodiment will be described with reference to the drawings.

For convenience of description, the same reference numerals are given to those configurations having the same functions as in the first embodiment, and the description will be omitted.

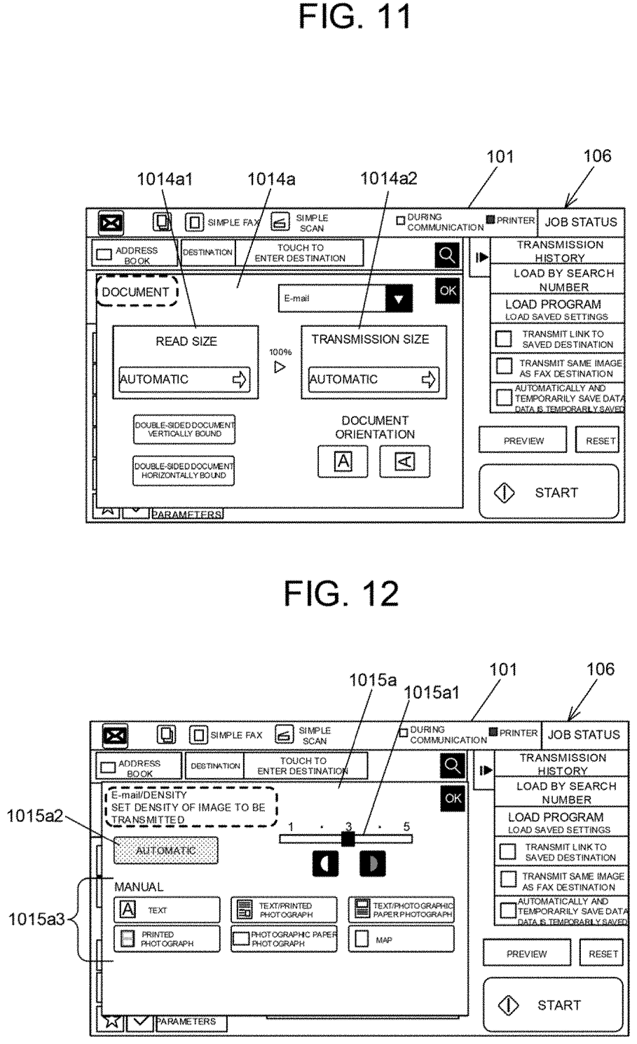

FIG. 11 is an explanatory diagram showing a document setting screen displayed on an operation unit of a data communication device according to a fourth embodiment.

In the fourth embodiment, in the data communication device 10, processing of reducing the data amount by changing the document size is performed as the data amount reduction processing.

When the document size is changed, a touch operation is performed with respect to the document setting key 1014 on the setting screen 101 shown in FIG. 4. As a result, a document setting screen 1014a is overlappingly displayed on the setting screen 101 as shown in FIG. 11.

The document setting screen 1014a includes a read size setting portion 1014a1 that sets an image read size, and a transmission size setting portion 1014a2 that sets a size of an image to be transmitted.

Further, the image data amount is changed by setting the transmission size with respect to the image read size. For example, the data amount of an image to be transmitted is reduced by setting the transmission size smaller than the image read size.

Furthermore, the document setting screen 1014a is configured to be capable of setting “vertically bound double-sided document”, “horizontally bound double-sided document”, the document orientation, and the like, as the image processing.

As a result of the configuration above, according to the fourth embodiment, in the data communication device 10 which performs e-mail communication, the data amount reduction processing of reducing an image to be attached to an e-mail includes the document setting screen 1014a, and changes the image data amount by setting the size of the image to be transmitted with respect to the image read size. Therefore, the image data amount can be reduced by setting the size of the image to be transmitted smaller than the image read size.

### Fifth Embodiment

Next, a fifth embodiment will be described with reference to the drawings.

For convenience of description, the same reference numerals are given to those configurations having the same functions as in the first embodiment, and the description will be omitted.

FIG. 12 is an explanatory diagram showing a density setting screen displayed on an operation unit of a data communication device according to a fifth embodiment.

In the fifth embodiment, in the data communication device 10, processing of reducing the data amount by changing the image density is performed as the data amount reduction processing.

When the image density is changed, a touch operation is performed with respect to the density setting key 1015 on the setting screen 101 shown in FIG. 4. As a result, a density setting screen 1015a is overlappingly displayed on the setting screen 101 as shown in FIG. 12.

The density setting screen 1015a includes a density alteration bar 1015a1 for setting/adjustment of the image density. A numerical value that specifies the density is displayed on the density alteration bar 1015a1, and the contrast of the image is adjusted by moving a cursor 1015a11.

Further, the image data amount is changed by setting the image density. For example, the image data amount can be reduced by setting the image density to a lower value.

Furthermore, the density setting screen 1015a includes an automatic setting key 1015a2 that automatically sets the density, and a manual setting key 1015a3 that manually sets the density. The manual setting key 1015a3, for example, enables manual setting/adjustment of the density using settings such as “text”, “text/printed photograph”, “text/photographic paper photograph”, “printed photograph”, “photographic paper photograph”, and “map”.

As a result of the configuration above, according to the fifth embodiment, in the data communication device 10 which performs e-mail communication, the data amount reduction processing of reducing an image to be attached to an e-mail includes the density setting screen 1015a and changes the image data amount by setting/adjustment of the image density. Therefore, the image data amount can be reduced by setting the image density to a lower value.

### Sixth Embodiment

Next, a sixth embodiment will be described with reference to the drawings.

For convenience of description, the same reference numerals are given to those configurations having the same functions as in the first embodiment, and the description will be omitted.

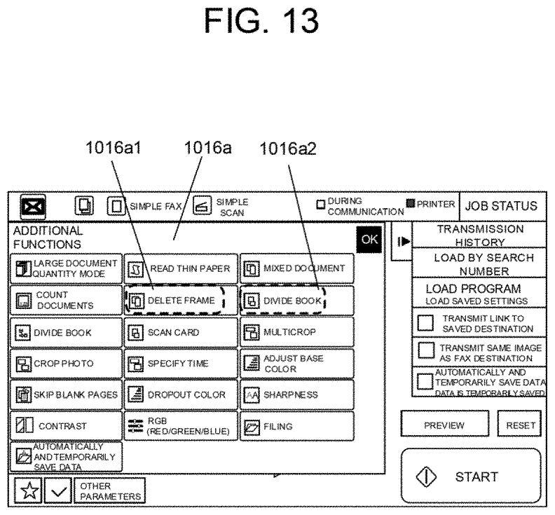

FIG. 13 is an explanatory diagram showing an additional function setting screen displayed on an operation unit of a data communication device according to the sixth embodiment.

In the sixth embodiment, in the data communication device 10, processing of reducing the image data amount by means of additional functions other than the reading mode setting, the resolution setting, the format setting, the document setting, and the image density setting is performed as the data amount reduction processing.

When the image data amount is changed using additional functions, a touch operation is performed with respect to the additional function setting key 1016 on the setting screen 101 shown in FIG. 4. As a result, an additional function setting screen 1016a is overlappingly displayed on the setting screen 101 as shown in FIG. 13.

The additional function setting screen 1016a includes a plurality of setting keys, and enables various settings to be performed according to the setting keys.

In the sixth embodiment, as functions for reducing the image data amount, a frame removal key 1016a1 can be selected to remove unnecessary data by deleting a frame, a page division key 1016a2 can be selected to reduce the data amount per image by dividing the image, and the like. In this manner, the data amount of the attached image can be reduced.

As a result of the configuration above, according to the sixth embodiment, in the data communication device 10 which performs e-mail communication, the data amount reduction processing of reducing an image to be attached to an e-mail is includes the additional function setting screen 1016a, and removing unnecessary data by deleting a frame, reducing the data amount per image by dividing the image, and the like. Therefore, the image data amount can be reduced.

As described above, the present invention is not limited to the embodiments above, and various changes may be made within the scope of the claims. It is clear that those skilled in the art may arrive at various modifications or corrections within the scope described in the claims. That is to say, embodiments obtained by combining technical means appropriately changed without departing from the scope of the present invention are also included in the technical scope of the present invention.

What is claimed is:

1. A data communication device that performs e-mail communication, the data communication device comprising:
an e-mail transmitter that attaches an image to an e-mail, and then transmits the e-mail;
an image data detector that detects a data amount of an input image;
an image data amount determiner that determines whether or not a data amount of the image attached to the e-mail exceeds a preset data amount;
a communication controller that enables transmission of the e-mail if the data amount of the image attached to the e-mail does not exceed the preset data amount; and
a data amount controller that performs data amount reduction processing of reducing the image data amount if the data amount of the image attached to the e-mail exceeds the preset data amount.

2. The data communication device according to claim 1, wherein
if a plurality of images to be attached to the e-mail exist, the communication controller can attach a plurality of images to a single e-mail within a range not exceeding the preset data amount and then transmit the e-mail.

3. The data communication device according to claim 1, wherein
if a data amount of a single image to be attached to the e-mail exceeds the preset data amount, the communication controller performs reduction processing using a predetermined setting, and if a data amount of the reduced image combined with one or more images does not exceed the preset data amount, the communication controller transmits the reduced image with one or more images as an attachment file of the same e-mail.

4. The data communication device according to claim 3, wherein
if a data amount of the reduced image combined with one or more images exceeds the preset data amount, the communication controller transmits the reduced image only.

5. The data communication device according to claim 1, wherein
the data amount reduction processing reduces the data amount by changing a reading mode of the image.

6. The data communication device according to claim 2, wherein
the data amount reduction processing reduces the data amount by changing a reading mode of the image.

7. The data communication device according to claim 3, wherein
the data amount reduction processing reduces the data amount by changing a reading mode of the image.

8. The data communication device according to claim 4, wherein
the data amount reduction processing reduces the data amount by changing a reading mode of the image.

9. The data communication device according to claim 1, wherein
the data amount reduction processing reduces the data amount by lowering a resolution of the image.

10. The data communication device according to claim 1, wherein
the data amount reduction processing reduces the data amount by changing a compression rate of the data of the image.

11. The data communication device according to claim 1, wherein
the data amount reduction processing reduces the data amount by reducing a size of the image.

12. The data communication device according to claim 1, wherein
the data amount reduction processing reduces the data amount by lowering a density of the image.

13. The data communication device according to claim 1, wherein
the data amount reduction processing reduces the data amount per image by dividing the image.

14. The data communication device according to claim 1, wherein
the data amount reduction processing reduces the data amount by removing unnecessary information from the image.

15. The data communication device according to claim 1, wherein
if an image having a data amount that exceeds the preset data amount exists, the communication controller notifies a user that an image having a data amount that exceeds the preset data amount exists, and selectively executes the data amount reduction processing according to a user instruction.

16. The data communication device according to claim 1, wherein
if the data amount reduction processing has been performed, information indicating that the data amount reduction processing has been performed is added to the e-mail.

17. The data communication device according to claim 16, wherein
if a plurality of e-mails with attached images exist, the communication controller successively transmits the e-mails from an e-mail with an attached image having a character string specifying the lowest numbered order of the attached images.

18. A data communication method for a data communication device that performs e-mail communication, data communication method comprising:
attaching an image to an e-mail, and then transmitting the e-mail;
detecting a data amount of an input image;
determining whether or not a data amount of the image attached to the e-mail exceeds a preset data amount;
enabling transmission of the e-mail if the data amount of the image attached to the e-mail does not exceed the preset data amount; and
performing data amount reduction processing of reducing the image data amount if the data amount of the image attached to the e-mail exceeds the preset data amount.
